(19) United States
(12) Patent Application Publication
(10) Pub. No.: US 2025/0013815 A1
(43) Pub. Date: Jan. 9, 2025

(54) ELECTRONIC TEXT GENERATION METHOD AND APPARATUS, DEVICE, AND MEDIUM

(71) Applicant: Beijing Bytedance Network Technology Co., Ltd., Beijing (CN)

(72) Inventors: Jiafeng Zheng, Beijing (CN); Weiwei Zhang, Beijing (CN)

(21) Appl. No.: 18/557,704

(22) PCT Filed: Jul. 5, 2022
(86) PCT No.: PCT/CN2022/103911

§ 371 Date: Oct. 27, 2023

(30) Foreign Application Priority Data
Jul. 13, 2021 (CN) 202110791957.2

(51) Int. Cl. G06F 40/106; G06F 40/109; G06F 40/114; G06F 40/205; G06T 11/60

(52) U.S. Cl. CPC G06F 40/106; G06F 40/109; G06F 40/114; G06F 40/205; G06T 11/60

(57) ABSTRACT

An electronic text generation method, apparatus, device and medium related to the technical field of data processing. The method includes: parsing a plurality of document segment contents belonging to a preset document segment type of a published document, and determining display attribute information of each document segment content, in which the preset document segment type includes at least one of a body document segment type or a flyleaf document segment type; determining a typesetting position of each document segment content based on preset typesetting attribute information of an electronic reader and the display attribute information; and performing processing of typesetting and drawing for the plurality of document segment contents at the typesetting position based on the display attribute information to generate an electronic text corresponding to the published document.

### CROSS-REFERENCE OF RELATED APPLICATIONS

This application claims the priority of the Chinese patent application filed on Jul. 13, 2021, with the application number of 202110791957.2 and the invention name of “method, apparatus, device and medium for electronic text generation”, the content of which is hereby incorporated in its entirety by reference.

### FIELD

The present disclosure relates to the technical field of data processing, and more particularly to an electronic text generation method, apparatus, device and medium.

### BACKGROUND

With the development of computer technology, users' needs for electronic reading are becoming more and more common. In order to meet users' needs for electronic reading, various readers have emerged.

In the related art, the text may be extracted from webpage content such as published documents, and the extracted text is typeset and displayed based on the default font size, etc. of the reader.

However, the above-described reader typesetting and displaying way for extracting text only displays and typesets the text content in the published document, and when typesetting the text content, the corresponding text content is displayed based on the default font size of the reader. On the one hand, no non-text content such as pictures in the published document is typeset. On the other hand, the displayed text content is displayed based on the default font size, etc. of the reader, and no display attribute of the text content in the published document is presented.

### SUMMARY

In order to solve the above technical problems or at least partially solve the above technical problems, the present disclosure provides an electronic text generation method, apparatus, device, and medium. The electronic text is converted based on the original display attribute information of the published document, and various types of document segments of the published document are indiscriminately converted. This not only achieves the effect of mixed picture and text in the electronic text, but also retains the original display mode of the published document.

The embodiments of the present disclosure provide an electronic text generation method, the method comprising: parsing a plurality of document segment contents belonging to a preset document segment type of a published document, and determining display attribute information of each document segment content, wherein the preset document segment type comprises at least one of a body document segment type or a flyleaf document segment type; determining a typesetting position of each document segment content based on preset typesetting attribute information of an electronic reader and the display attribute information; and performing processing of typesetting and drawing for the plurality of document segment contents at the typesetting position based on the display attribute information to generate an electronic text corresponding to the published document.

The embodiments of the present disclosure further provide an electronic text generation apparatus, the apparatus comprising: a first determination module configured to parse a plurality of document segment contents belonging to a preset document segment type of a published document, and determining display attribute information of each document segment content, wherein the preset document segment type comprises at least one of a body document segment type or a flyleaf document segment type; a second determination module configured to determine a typesetting position of each document segment content based on preset typesetting attribute information of an electronic reader and the display attribute information; a generation module configured to perform processing of typesetting and drawing for the plurality of document segment contents at the typesetting position based on the display attribute information to generate an electronic text corresponding to the published document.

The embodiments of the present disclosure further provide an electronic device, the electronic device comprising: a processor; a memory for storing processor-executable instructions; the processor used to read the executable instructions from the memory and execute the instructions to implement an electronic text generation method provided by the embodiments of the present disclosure.

The embodiments of the present disclosure further provide a computer readable storage medium, wherein the storage medium stores a computer program for performing electronic text generation method provided by the embodiments of the present disclosure.

The technical solution provided by the embodiments of the present disclosure has the following advantages compared with related technologies:
parsing a plurality of document segment contents belonging to a preset document segment type of a published document, and determining display attribute information of each document segment content, wherein the preset document segment type comprises at least one of a body document segment type or a flyleaf document segment type; determining a typesetting position of each document segment content based on preset typesetting attribute information of an electronic reader and the display attribute information; and performing processing of typesetting and drawing for the plurality of document segment contents at the typesetting position based on the display attribute information to generate an electronic text corresponding to the published document.

### BRIEF DESCRIPTION OF THE DRAWINGS

In combination with the accompanying drawings and with reference to the following detailed description, the above and other features, advantages and aspects of various embodiments of the present disclosure will become more apparent. Throughout the drawings, the same or similar reference numerals represent the same or similar elements. It should be understood that the drawings are illustrative and that the components and elements are not necessarily drawn scale.

FIG. 1 is a schematic diagram of a paging display scene of a published document of the related art;

FIG. 2 is a schematic diagram of a paged display scene of a published document provided by the embodiments of the present disclosure;

FIG. 3 is a schematic flowchart of an electronic text generation method provided by the embodiments of the present disclosure;

FIG. 4 is a schematic diagram of a document segment content extraction result provided by the embodiments of the present disclosure;

FIG. 5 is a schematic flowchart of another electronic text generation method provided by the embodiments of the present disclosure;

FIG. 6 is a schematic diagram of another paged display scene of a published document provided by the embodiments of the present disclosure;

FIG. 7 is a schematic diagram of another paged display scene of a published document provided by the embodiments of the present disclosure;

FIG. 8 is a schematic flowchart of another electronic text generation method provided by the embodiments of the present disclosure;

FIG. 9 is a schematic diagram of another paged display scene of a published document provided by the embodiments of the present disclosure;

FIG. 10 is a schematic flowchart of another electronic text generation method provided by the embodiments of the present disclosure;

FIG. 11 (a) is a schematic diagram of another paged display scene of a published document provided by the embodiments of the present disclosure;

FIG. 11 (b) is a schematic diagram of another paged display scene of a published document provided by the embodiments of the present disclosure;

FIG. 12 is a schematic flowchart of another electronic text generation method provided by the embodiments of the present disclosure;

FIG. 13 is a schematic diagram of a hierarchical of a directory paragraph provided by the embodiments of the present disclosure;

FIG. 14 is a structural schematic diagram of a paging apparatus of a published document provided by the embodiments of the present disclosure;

FIG. 15 is a schematic structural diagram of an electronic device provided by the embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in different order and/or in parallel. Furthermore, method implementations may include additional steps and/or omit steps that are shown. The scope of the present disclosure is not limited in this regard.

The terms “comprise” and its variants used herein are to be read as open terms that mean “include, but is not limited to.” The term “based on” is to be read as “based at least in part on.” The term “one embodiment” is to be read as “at least one embodiment,” the term “another embodiment” is to be read as “at least one another embodiment,” and the term “some embodiments” is to be read as “at least some embodiments.” Other definitions, explicit and implicit, might be included below.

It should be noted that concepts “first,” “second” and the like mentioned in the present disclosure are only used to distinguish between different apparatuses, modules or units, rather than limiting the order or interdependence of the functions performed by these apparatuses, modules or units.

It should be noted that modifications “one” and “more” mentioned in the present disclosure are schematic and not limiting, and should be understood as “one or more” to those skilled in the art unless otherwise specified.

Names of messages or information exchanged between the plurality of apparatuses in implementations of the present disclosure are used for illustrative purposes only and are not intended to limit the scope of those messages or information.

In order to better understand the embodiments of the present disclosure for those skilled in the art, the meanings of several concepts involved in the present disclosure are first introduced.

Published document: webpage content corresponding to the publications for online preview, including pictures, texts, etc., for example, online novels, etc., or it can also be pictures of paper publications.

Electronic reader: applications for typesetting and displaying published documents, the typeset documents of the electronic reader are paged and displayed based on the size of the display screen of a terminal device where it is located. The terminal device, including but not limited to mobile phones, computers, tablets, and other devices with any display screen.

In the related art, as mentioned in the background above, when the electronic reader converts the published document, it only extracts the text in the published document, and the electronic reader only displays the text in the published document, and cannot restore other information of the published document, which affects the reading experience.

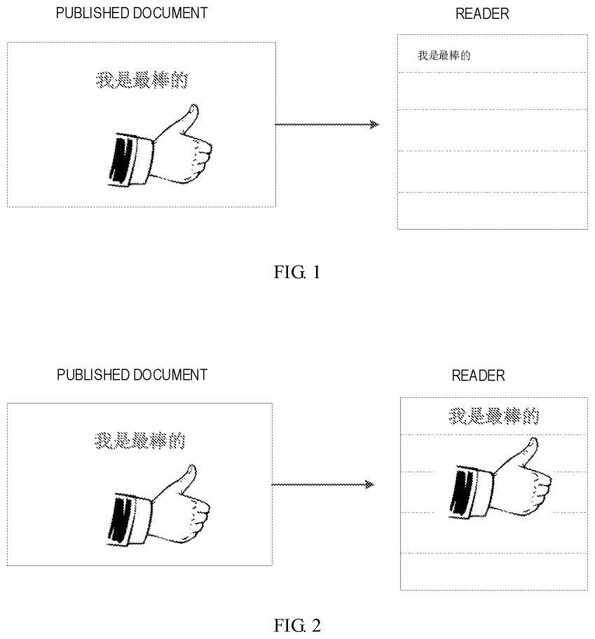

For example, when the published document includes [symbol] bold, yellow (the color is identified by grayscale value in the figure), Song font, 14-pound text and a like picture, as shown in the left figure of FIG. 1. In the related technologies, as shown in the right figure of FIG. 1, only [symbol] corresponding to the default size style of the electronic reader is displayed on the electronic reader, and the text style is black, Song font, and 8 pounds.

Apparently, in the related art, not only the display mode of the text in the published document cannot be restored, but also non-text content such as like pictures in the published document cannot be displayed.

To solve the above problems, the embodiments of the present disclosure provide an electronic text generation method. In this method, it is realized that on the electronic reader it can be typeset and drawn to produce a typesetting effect consistent with the display form and content of the published document.

For example, when the published document includes, as shown in the left figure of FIG. 2, [symbol] bold, yellow (the color is identified by grayscale value in the figure), Song font, 14-pound text and a like picture, on the electronic text after the typeset of the electronic reader in the embodiments of the present disclosure, as shown in the right figure of FIG. 2, it is typeset and displayed [symbol] bold, yellow (the color is identified by grayscale value in the figure), Song font, 14-pound text and the like picture.

The electronic text generation method will be described below in combination with specific embodiments.

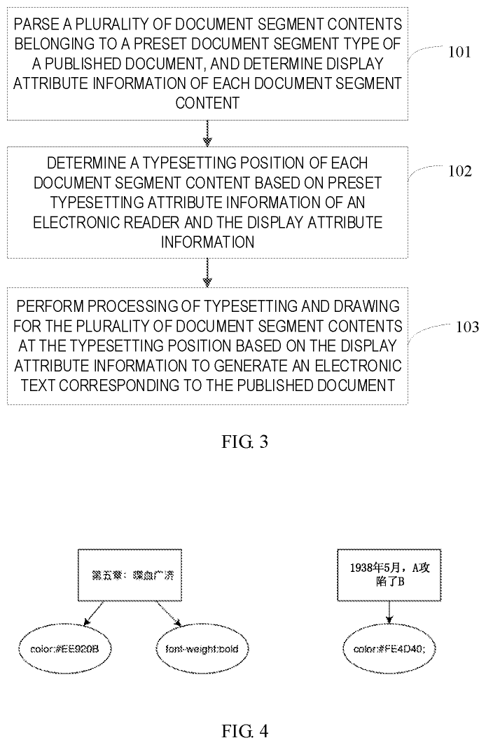

FIG. 3 is a schematic flowchart of the electronic text generation method provided by the embodiments of the present disclosure. The method may be performed by an electronic text generation apparatus, wherein the apparatus may be implemented in software and/or hardware, and can generally be integrated in an electronic device. As shown in FIG. 3, the method includes steps.

Step 301, parse a plurality of document segment contents belonging to a preset document segment type of a published document, and determining display attribute information of each document segment content.

Herein the preset document segment type comprises at least one of a body document segment type or a flyleaf document segment type.

In the embodiments of the present disclosure, in order to identify document segment content for the body document segment type, it may be based on a paragraph order of the published document to identify each document segment, and determine the document segment type of each document segment. Based on the document segment type the body document segment is determined and the corresponding display attribute information is obtained.

Herein, in the embodiments of the present disclosure, the body document segment type may be determined based on a document code identifier corresponding to the document segment or the document position. For example, when the published document is an electronic document, a type of attribute value of the document segment content code is determined. If the type of attribute value belongs to a preset attribute value of the body document segment type, the corresponding document segment content is determined as the body document segment or the like.

In the embodiments of the present disclosure, based on the document code identifier corresponding to the document segment or document position, it is determined whether the document segment type is a flyleaf document segment type. for example, after determining the body document segment, the adjacent document segment before the first body document segment in the published document is determined as the flyleaf document segment, etc. Herein, the document segment content of the body document segment may include a text document segment or a picture document segment, etc., and the display attribute information includes at least one of a size display attribute information or a style display attribute information. If the document segment content is text content, the corresponding size display attribute information is the font related to the font size, whether the font is bold, the font size and whether the font is inclined, etc., and the corresponding style display attribute information is a color, an animation effect, etc. If the document segment content is picture content, the corresponding size display attribute information is the picture length, the picture width, etc. related to the picture size, and the corresponding style display attribute information is the picture color, the picture animation effect, etc.

It should be noted that in different application scenarios, the way of determining each document segment content of the published document and the corresponding display attribute information is different. An example is as follows.

### EXAMPLE 1

In this example, the published document is webpage content.

In the embodiment, a document segment start mark and a document segment end mark corresponding to the preset document segment type is identified, and a content from each document segment start mark to the next document segment end mark is extracted as each document segment content.

Herein the document segment start mark and the document segment end mark may be start code and end code of each segment content extracted based on webpage code.

For example, when the HTML code of the published document is as follows, the document segment start mark and the document segment end mark may be “h1”, “/h1”, “P”, “/P” and the like.

```
HTML
< body >
  < div >
    < h1 > [symbol]   : [symbol]   </h1 >
    < p >1938 [symbol]   5 [symbol]   , A [symbol]   B</p >
  </div >
</body >
```

Further, based on the CSS file corresponding to the HTML file, the corresponding display attribute information may be determined. For example, the CSS file corresponding to the HTML file is:

```
CSS
H1
{
  Color: #EE920B;
}
p
{
  Color: #FE4D40;
}
.title {
  Font-weight: bold;
}
```

Based on the corresponding CSS file,
in this example, the rich text composed of the obtained document segment content and display attribute information is shown in FIG. 4. Herein, the attributes of h1 and title in the CSS are used for the document segment content [symbol] : [symbol] so the corresponding display attribute information is to bold the characters and set the color of #EE920B. The attribute of color in the CSS is used for the document segment content “1938 [symbol] 5 [symbol] , A [symbol] B”, so the corresponding display attribute information is to set the color of “color: #FE4D40” for the characters.

### EXAMPLE 2

In this example, the published document is in picture form.

In this example, the picture corresponding to the preset document segment type in the published document is binarized to obtain multiple connected domains formed by the above pictures. Then, the content corresponding to each connected domain is used as one document segment content. Furthermore, the image features of the content in each connected domain are parsed, and the display attribute information of each document segment content is determined based on the image features. For example, the color attribute information is determined based on the color image features.

Step 302, determine a typesetting position of each document segment content based on preset typesetting attribute information of an electronic reader and the display attribute information.

Step 303, perform processing of typesetting and drawing for the plurality of document segment contents at the typesetting position based on the display attribute information to generate an electronic text corresponding to the published document.

In this embodiment, the preset typesetting attribute information of the electronic reader includes the default style attribute information and the default size display attribute information set by the electronic reader for its own reader display style. Herein, the default style attribute information includes but is not limited to the font size. The default size display attribute information includes the display size of each row and each column.

In the embodiment, in order to retain the display style for the document segment content in the published document, in combination with the typesetting attribute information and display attribute information, the typesetting position of each document segment content is determined. Further, the processing of typesetting and drawing for the plurality of document segment contents at the typesetting position is performed based on the display attribute information to generate an electronic text corresponding to the published document.

It should be understood that when determining the typesetting position of each document segment content based on the display attribute information and typesetting attribute information, any way of combining the display attribute information and typesetting attribute information for typesetting and displaying may be used. In order to make those skilled in the art more clearly understand this solution, the following specific examples will be described.

In one embodiment of the present disclosure, as shown in FIG. 5, determining a typesetting position of each document segment content based on preset typesetting attribute information of an electronic reader and the display attribute information, comprising steps.

Step 501, determine, based on the display attribute information, a first display size of each content unit in each document segment content.

In this embodiment, if a content unit is text content, a size style and a font style of the text content is obtained, and a first display size of the text content based on the size style and font style is determined. Herein, the font style includes but is not limited to whether the font is inclined, the font type, and whether the font is bold.

In this embodiment, a deep learning model may be built in advance, and the size style and font style are input into the corresponding deep learning model to obtain the corresponding first display size. When a content unit is picture content, the picture size of the picture content is obtained, and a first display size of the picture content is determined based on the picture size. In some scenarios, the picture size may be obtained through the code that extracts the size of the picture in the published document, and then the picture size may be used as the first display size.

Step 502, determine, based on the typesetting attribute information, a second display size of each display unit in the electronic reader.

Herein, each display unit may be the smallest display unit of the electronic reader. For example, the display unit may be a row or a column, etc. If the electronic reader displays cells in accordance with a checkerboard, the display unit is one cell.

Thus, the second display size of each display unit may be the row width, the column height, etc. of the electronic reader.

Step 503, typeset each content unit based on the second display size and the first display size to determine the typesetting position of each document segment content.

In the embodiment, each content unit is typeset based on the second display size and the first display size to determine the typesetting position of each document segment content. For example, the first display size of the content display unit A includes a row width of 2 and a column height of 5, and the second display size is a row width of 10 and a column height of 1 on the electronic reader. It starts typesetting from the next initial position, and the position of the row width of 2 and occupying 5 columns is taken as the typesetting position. The processing of typesetting and drawing at the typesetting position is performed based on the display attribute information, and a corresponding electronic text retaining the display attribute in the published document is generated.

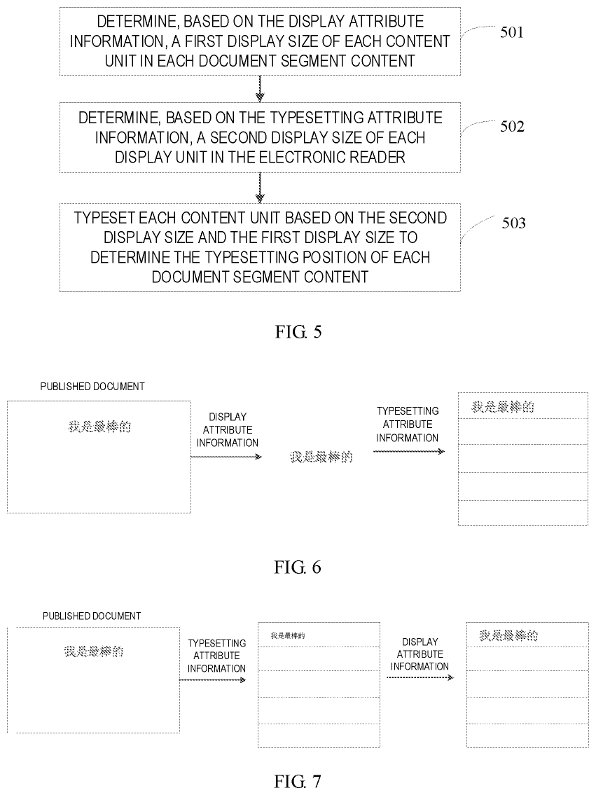

For example, if the corresponding document segment content is [symbol] the display attribute information is shown in FIG. 6. It may be based on display attribute information, [symbol] is processed corresponding to rich text content, and then, in accordance with the typesetting attribute information of a target reader is typeset to generate the corresponding electronic text.

In another embodiment of the present disclosure, regardless of the display attribute information corresponding to the document segment content, first based on the typesetting attribute information the corresponding document segment content is typeset, and the typesetting content is generated.

For example, if the corresponding document segment content is [symbol] the display attribute information shown in FIG. 7. It may first be based on the typesetting attribute information, and [symbol] is typeset in accordance with the default display attribute information of the electronic readers to generate the corresponding typesetting content.

In the embodiment, after typesetting the corresponding document segment content to generate the typesetting content, each content unit of each document segment content substantially has basically determined the initial position. Then, based on the display attribute information, the typesetting content is typeset in accordance with the display attribute information, and the final typesetting and drawing position obtained is the final typesetting position.

Continuing with the above example as an example, with reference to FIG. 7, after obtaining the typesetting content, based on the corresponding display attribute information to determine the typesetting position for the typesetting content, the final typesetting position is obtained, and the display effect of [symbol] in the published document is restored.

Of course, in the actual performing process, in order to prevent the electronic reader from being unable to fully present the display attribute information of the document segment content in the published document, different compromises can be made to the display attribute information based on different application scenarios. Examples are as follows.

### EXAMPLE 1

In this example, the range of display attribute information that can be displayed by the electronic reader may be set in advance. For example, the type range of display attributes may be set in advance. For example, the display font size range, the picture size range, etc. may be set in advance.

Before performing processing of typesetting and drawing for the corresponding document segment content based on the display attribute information and typesetting attribute information, it is determined whether the display attribute information corresponding to the document segment content in the published document exceeds the range of the preset display attribute information. If it exceeds, the excess display attribute information is replaced with the default display attribute information corresponding to the electronic reader.

### EXAMPLE 2

In this example, a maximum value of the display attribute information that the electronic reader can display may be set in advance. For example, the maximum font size, the maximum picture size, etc. displayed may be set in advance.

Before performing processing of typesetting and drawing for the corresponding document segment content based on the display attribute information and typesetting attribute information, it is judged whether the display attribute information exceeds the maximum value of the display attribute information. If it exceeds, the ratio of the display attribute information that the document segment content in the published document exceeds and the corresponding maximum value is computed. The display attribute information that the corresponding document segment content exceeds is scaled based on this ratio.

In the actual performing process, for the missing display attribute information of the corresponding document segment content, i.e., the display attribute information which not specifically specified in the published document, the default display attribute information of the electronic reader may prevail.

Based on the above description, the example illustrates how to typeset and draw the document segment content, but in practical applications, some document segment content may also correspond to other information. For example, for the document segment content of the flyleaf in the published document, it may also include background pictures, etc. Therefore, in one embodiment of the present disclosure, a background picture may also be rendered for the document segment content on the flyleaf to further restore the display mode of the published document.

In the embodiment, before performing processing of typesetting and drawing for the corresponding document segment content, a background picture attribute value of the corresponding document segment content is also obtained. Based on the background picture attribute value, it is determined whether the corresponding background picture exists in the corresponding document segment content. For example, when the published document is a webpage form, the corresponding background picture attribute value is the value corresponding to the chapter_type field. If the corresponding value of the chapter_type field is 1, it indicates that the corresponding background picture exists in the corresponding document segment content.

Then, the corresponding background picture may be obtained. For example, a background picture data, etc. corresponding to the chapter_type field is read from the HTML of the webpage content. When performing processing of typesetting and drawing for the corresponding document segment content, the typesetting position of the corresponding document segment content is determined based on the display attribute information and typesetting attribute information of the corresponding document segment content. Furthermore, the background picture is rendered at the typesetting position, and on the background picture, the corresponding document segment content is performed processing of typesetting and drawing based on the display attribute information and typesetting attribute information of the corresponding document segment content. That is, first the background picture is rendered, and then the corresponding document segment content is typeset and drawn.

In summary, the electronic text generation method of the embodiments of the present disclosure comprises: parsing a plurality of document segment contents belonging to a preset document segment type of a published document, and determining display attribute information of each document segment content, wherein the preset document segment type comprises at least one of a body document segment type or a flyleaf document segment type; determining a typesetting position of each document segment content based on preset typesetting attribute information of an electronic reader and the display attribute information; and performing processing of typesetting and drawing for the plurality of document segment contents at the typesetting position based on the display attribute information to generate an electronic text corresponding to the published document. Thus, the electronic text is converted based on the original display attribute information of the published document, and various types of document segments of the published document are indiscriminately converted. This not only achieves the effect of mixed picture and text in the electronic text, but also retains the original display mode of the published document.

It should be noted that when the electronic text is finally displayed on the screen of the terminal device, it will also be paged based on the display size of the target display device where the electronic reader is located. As shown in FIG. 8, in one embodiment of the present disclosure, the method further includes:

Step 801, obtain display size information of a target display device.

Herein, the display size information corresponds to the screen size of the target display device when the electronic reader is displayed.

Step 802, page the electronic text based on the display size information and the typesetting attribute information to generate a plurality of pagings corresponding to the electronic text.

It may be understood that the display size information determines the size of each paging displayed by the current electronic reader on the target display device. For example, the display length, the display height, the number of rows or columns displayed, etc. of each paging may be determined.

In the embodiment, if the typesetting mode corresponding to the typesetting attribute information is arranged line by line, then based on the displayable height corresponding to the display size information, how many rows of the electronic text is determined as a paging. Of course, if at this time the typesetting row width in the typesetting attribute information is inconsistent with the display row width of the target display device, the display size of each row may be adjusted in the electronic text. For example, if the display row width of the target display device is smaller than the row width of each row in the electronic text is small, the display content of each row in the electronic text may be reduced based on the ratio of the display row width of the target display device to the row width of each row in the electronic text.

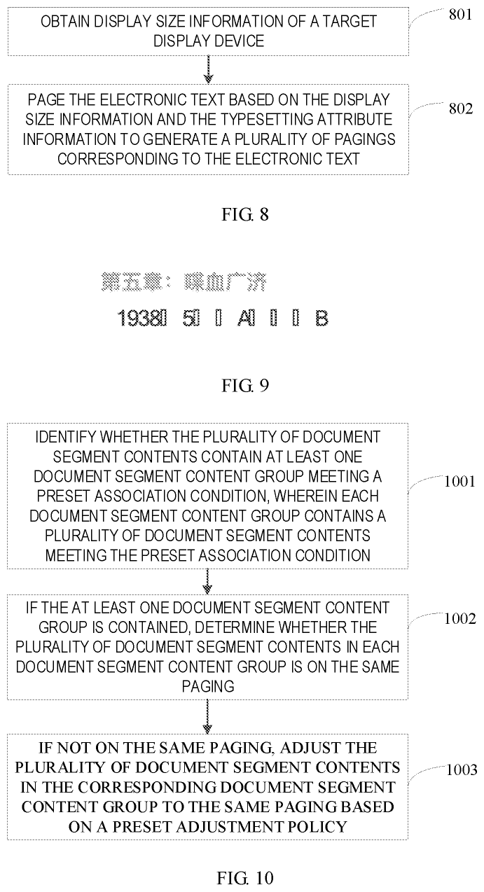

Based on the size information in the typesetting attribute information, the document segment content may be laid out into at least one paging, and based on the display attribute information, the document segment content is displayed, and the original display mode in the published document is retained. Continuing with the example shown in FIG. 4, based on the display attribute information and the typesetting attribute information, the corresponding document segment content is performed processing of typesetting and drawing in accordance with paragraph order, as shown in FIG. 9 (the color is identified by grayscale value in the figure), and the corresponding display attribute information is retained on the reader paging.

During the process of typesetting and drawing, in order to further improve the reading experience, some document segment content with strong correlation may be processed and displayed on the same page. Herein, the document segment content with stronger correlation may be type-related, for example, the document segment content where the brief description of the drawings is located and the document segment content where the corresponding drawings are located. The document segment content with stronger correlation may also be content-related, for example, the document segment content where the number of the chapter is located, and the document segment content where the title of the chapter is located.

In one embodiment of the present disclosure, as shown in FIG. 10, the method further includes steps.

Step 1001, identify whether the plurality of document segment contents contain at least one document segment content group meeting a preset association condition, wherein each document segment content group contains a plurality of document segment contents meeting the preset association condition.

In this embodiment, whether the plurality of document segment contents contain at least one document segment content group that satisfies the preset association conditions is identified, wherein each document segment content group contains the plurality of document segment contents that satisfy the preset association conditions. In some scenarios, the preset association conditions may be used to restrict the document segment content corresponding to the brief description of the drawings and the document segment content corresponding to the drawings mentioned above.

Step 1002, if the at least one document segment content group is contained, determine whether the plurality of document segment contents in each document segment content group is on the same paging.

For example, the document segment content in accordance with the order in the published document is arranged segment by segment. If the current document segment content to be typeset and drawn is the nth document segment content and n is greater than 1, it may be determined whether the first (n-1)th document segment content includes the target document segment content associated with the nth document segment content. As mentioned above, the associated target document segment content may be type-related or content-related, etc.

It should be noted that in different application scenarios, the way to determine whether the first (n-1)th document segment content includes the target document segment content associated with the nth document segment content is different. An example is as follows.

### EXAMPLE 1

In this example, if the published document is in the form of a webpage, the groupId attribute of each document segment content in the first (n-1)th document segment contents and the nth document segment content may be queried. If the groupId attribute is the same, the corresponding document segment content is considered to be the target document segment content of the nth document segment content.

### EXAMPLE 2

In this example, for identifying the relevance of adjacent document segment content, the document segment content type of the nth document segment content may be identified, and the paragraph type of the document segment content of the (n-1)th segment may be identified. If the paragraph type of the document segment content of the nth segment belongs to the corresponding document segment content type of the document segment content type of the nth document segment content, the document segment content of the (n-1)th segment is determined to be the target document segment content of the nth document segment content.

Further, if the first (n-1)th document segment content includes the target document segment content associated with the nth document segment content, the first reader paging where the target document segment content is located is determined.

In some possible implementations, the reader paging is sorted based on the front-to-back order and a correspondence between each document segment content and the sorting number of the reader paging in which it is located may be built in advance. Thus, the correspondence may be queried to determine the first reader paging where the target document segment content is located.

Further, based on the display attribute information and typesetting attribute information of the n-th document segment content, the second reader paging where the n-th paragraph is determined.

In this embodiment, after typesetting and drawing the (n-1)th document segment content, the next display position on the reader paging is determined to be the beginning typesetting position of the n-th document segment content. If the electronic reader paging is sorted line by line, the next display position is the first blank row after typesetting and drawing the (n-1)th document segment content. If the electronic reader paging is sorted column by column, the next display position is the first blank column after typesetting and drawing the (n-1)th document segment content. If the next display position is located on the next paging, the corresponding beginning typesetting position is the first display position of the next paging.

Starting from the beginning typesetting position of the nth document segment content, based on the display attribute information and typesetting attribute information of the nth document segment content, the second reader paging where the nth paragraph is located is obtained.

After obtaining the second reader paging, it is determined whether the first reader paging and the second reader paging are the same.

For example, it is determined whether the page sorting number of the first reader paging and the page sorting number of the second reader is the same and the like.

Step 1003, if not on the same paging, adjust the plurality of document segment contents in the corresponding document segment content group to the same paging based on a preset adjustment policy.

In the embodiment, if not on the same paging, based on the preset adjustment policy the plurality of document segment contents in the corresponding document segment content group is adjusted to the same paging.

For example, the typesetting position of at least one document segment content in the corresponding document segment content group may be adjusted so that the plurality of document segment contents in the corresponding document segment content group belongs to the same paging. For example, the content display size of at least one document segment content in the corresponding document segment content group may be adjusted so that the plurality of document segment contents in the corresponding document segment content group belongs to the same paging.

Continuing with the above example, if the first reader paging and the second reader paging are different, the target document segment content is adjusted, or the reader paging where the nth document segment content is located is adjusted, so that the nth document segment content and the target document segment content are typeset on the same reader paging.

In the embodiment, if the first reader paging and the second reader paging are different, in order to make the target document segment content and the n-th document segment content displayed on the same page, the target document segment content or the reader paging where the n-th document segment content may be adjusted, so that the n-th document segment content and the target document segment content are typeset on the same reader paging.

It should be noted that in different application scenarios, the way that the nth document segment content and the target document segment content are typeset on the same reader paging is different. An example is as follows.

### EXAMPLE 1

In this example, the beginning typesetting position of the target document segment content is determined, and the beginning typesetting position of the target document segment content is updated to the first typesetting position of the second reader paging, and the target document segment content is typeset. Then, the nth document segment content is typeset and drawn after the target document segment content, so that the nth document segment content and the target document segment content are typeset on the same reader paging.

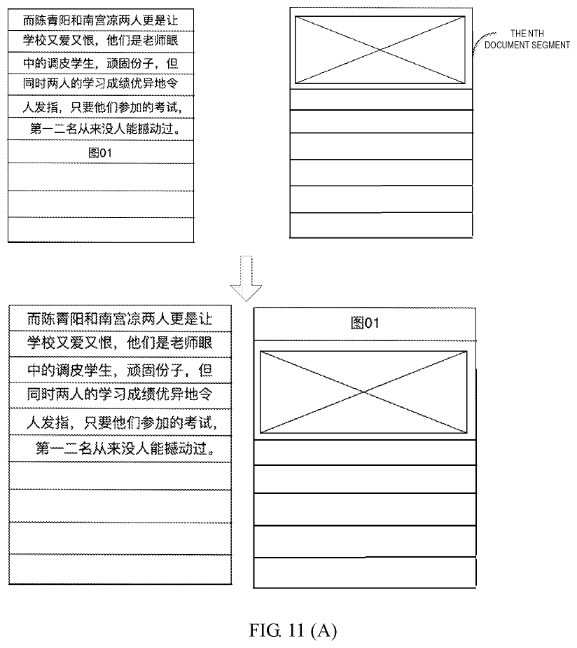

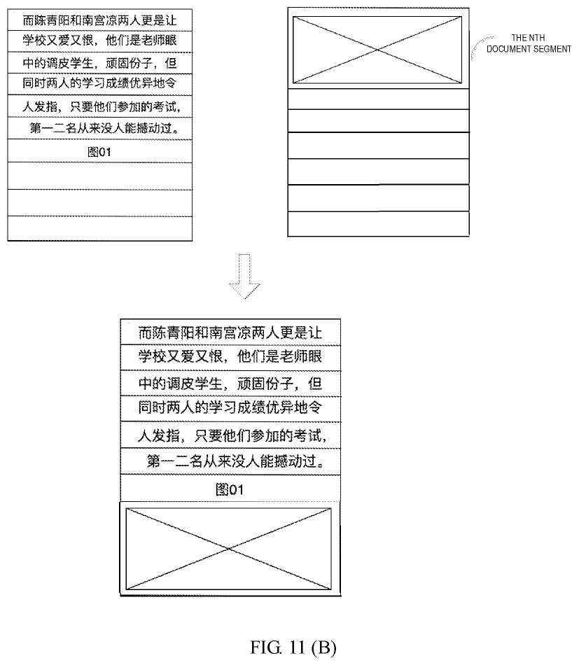

For example, as shown in FIG. 11 (a), the target document segment content is the document segment content where [symbol] 01” is located, and the nth document segment content is the corresponding picture. Since [symbol] 01” and the picture are not on one page, [symbol] 01” is moved to the first row of the reader page where the picture is located and rendered. It can be seen that the picture is rendered after the document segment content of [symbol] 01” and [symbol] 01” and the picture are realized on the same reader page.

### EXAMPLE 2

In this example, the target document segment content is reduced, and/or the size of the nth document segment content is reduced, so that the nth document segment content and the target document segment content are typeset on the same reader paging. The reduction in size is determined based on the display size of each reading page, and the specific implementation method may be implemented by the related technology, which is not repeated here.

For example, as shown in FIG. 11 (b), the target document segment content is the document segment content where [symbol] 01” is located, and the nth document segment content is the corresponding picture. [symbol] 01” and the picture are not on one page, but there is a remaining blank area on the page where [symbol] 01” is located. Therefore, the size of the picture may be reduced based on the remaining blank area, so that [symbol] 01” and the picture are displayed on the same reader page.

It should be emphasized that the above-mentioned processing method for the associated document segment content is only a possible example. Any method that the associated paragraph may be processed into the same page should be executable in this embodiment and will not be illustrated here one by one. Of course, if the associated document segment contains a lot of content, it cannot be displayed on one page, and the above processing method does not need to be performed.

In summary, the electronic text generation method of the embodiments of the present disclosure, after generating the electronic text corresponding to the electronic reader, the electronic text may also be paged and displayed based on the target display device. Not only the text content in the published document may be displayed when paging and displaying, but also other non-text content such as the corresponding picture content is displayed, and the display attribute information in the published document is reflected when displaying. Thus, the reading experience is improved.

Based on the above embodiments, it is also necessary to specify the directory part of the published document. The directory of the publication is different from the novels seen in the past. The directory design of the novel is generally a single-hierarchy structure, that is, a chapter is an independent chapter structure, and there is no situation where there are subsections within the chapter. The directory structure of the publication is different. There may be volumes, chapters, sections, and even subdirectories with some sub-point labels under the section, forming a multi-hierarchy directory structure. If the directory structure of the publication is displayed in a flat novel style, the display may not be clear enough, and the volumes, chapters, and sections belong to the same layer, which is quite chaotic, and the user Experience is not good.

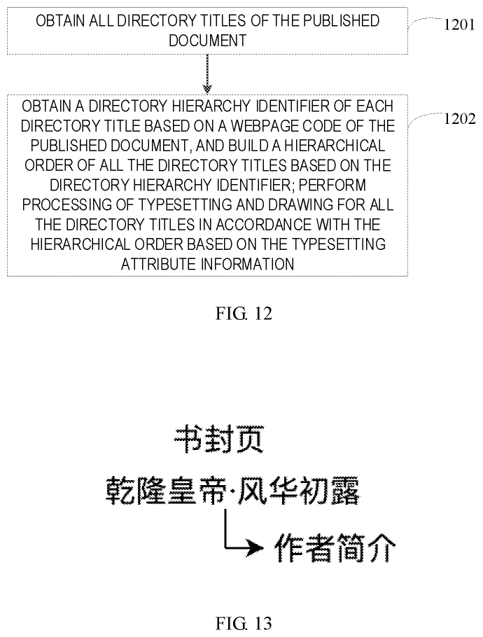

Therefore, in one embodiment of the present disclosure, the directory is also hierarchically structured, and the specific method is shown in FIG. 12.

Step 1201, obtain all directory titles of the published document.

In the embodiment, the directory title is determined in all document segment content of the published document. For example, if the published document is webpage content, the content which type attribute is the directory attribute may be obtained as the directory title. For another example, the document segment content in the published document may be identified separately, and the corresponding document segment content is directly determined as the directory title.

Step 1202, obtain a directory hierarchy identifier of each directory title based on a webpage code of the published document, and build a hierarchical order of all the directory titles based on the directory hierarchy identifier; perform processing of typesetting and drawing for all the directory titles in accordance with the hierarchical order based on the typesetting attribute information.

Herein, the directory hierarchy identifier is used to determine the chapter, section and other hierarchies where the directory is located. The directory hierarchy identifier may be a node id or a literal or alphabetical form, etc.

In some possible embodiments, if the directory hierarchy identifier is in the form of a node id, it may include catalog_id, item_id, parent_catalog_id, etc.

As mentioned above, directory hierarchy identifiers are used to determine the hierarchy of chapters, sections, etc. where the directory is located. Therefore, the hierarchy of the target paragraph may be built based on directory hierarchy identifiers, the volume, chapter, section, etc. to which the corresponding directory paragraph belongs may be determined based on directory hierarchy identifiers, and the hierarchy of the target paragraph may be built based on the volume, chapter, section, etc. of all directory document segment contents.

Continuing with the example that directory hierarchy identifier is the node id, if the json code corresponding to the directory paragraph is as follows, the catalog_id in the directory structure is used as the unique flag of this directory node, and the parent_catalog_id is used as the flag of the directory node indexed to its parent node. For example, for directory paragraph [symbol] its corresponding parent_catalog_id is 1, and the catalog_id corresponding to the directory paragraph [symbol] is 1. Apparently, the higher-hierarchy directory paragraph corresponding to [symbol] is [symbol] [symbol] Based on the relevant node id, the hierarchy of the directory paragraph may be obtained.

```
JSON
{
  “catalog_id”: “0”,
  “catalog_title”: “Book cover page”,
  “item_id”: “6834780414964400648”,
  “chapter_type”: 1
}, {
  “catalog_id”: “1”,
  “catalog_title”: “Emperor Qianlong · First Dew of Fenghua”,
  “item_id”: “6834780415627100550”,
  “chapter_type”: 0
}, {
  “catalog_id”: “2”,
  “catalog_title”: “About the Author”,
  “parent_catalog_id”: “1”,
  “item_id”: “6834780416218497550”,
  “FragmentId”: “heading_id_2”,
  “chapter_type”: 0
}
```

In this embodiment, in order to intuitively guide the user to the directory, based on the preset typesetting display information of the hierarchy, the typesetting position of the directory paragraph on the corresponding reader paging is adjusted, so that the directory paragraph after adjusting the typesetting position intuitively reflects the hierarchical relationship. Herein, the preset typesetting display information of the hierarchy may be any information which controls the typesetting of the target paragraph in accordance with the directory hierarchy identifier.

For example, the typesetting display information may be as shown in FIG. 13, the blank size is determined before the directory paragraph corresponding to each hierarchy is typeset, and the typesetting position of the directory paragraph of each hierarchy is controlled based on the blank size. Generally, the blank size in front of the directory paragraph at the lower hierarchy is larger. The typesetting display information may also be as shown in FIG. 13, a link indicator such as an “arrow” corresponding to the directory paragraph at the upper hierarchy is added before the directory paragraph corresponding to the relevant hierarchy is typeset.

Further, considering the related art, the mixed directory title when switching, will give the user a very bad experience. In one embodiment of the present disclosure, the directory paragraph of the chapter may be controlled to jump to the first page of the chapter, the directory paragraph of the section may be controlled to jump to the reader page corresponding to the section in the chapter.

Specifically, after building the above hierarchy, the method also includes:
determining all body document segment contents of the body document segment type of the published document; obtaining, based on the webpage code of the published document, a belonged directory hierarchy identifier to which the body paragraph belongs; determining the body paragraph in all document segment contents in the published document, and obtaining the belonged directory hierarchy identifier to which the body document segment content belongs. For example, the hierarchy identifier id corresponding to the body document segment content may be determined.

Furthermore, based on the belonged directory hierarchy identifier, target body paragraphs corresponding to the all directory titles is determined in all the body document segment contents, and the typesetting beginning position corresponding to the target body document segment content is determined in at least one reader paging. For example, for the corresponding first reader paging, a correspondence between the directory paragraph and the corresponding typesetting beginning position is built in response to the jump operation of the directory paragraph based on the correspondence.

Continuing with the above example, the sections in the html file of the body paragraph in the parse phase will have the same fragment_id as in the directory paragraph, so when clicking on the section in the directory to jump, all the typesetting beginning positions of the chapter will be obtained through the chapter id. For example, for the reader paging, all the typesetting positions are traversed to find the typesetting beginning position corresponding to the fragment_id of the directory and jump to it. For example, for the reader paging, all reader pagings are traversed to find the reader paging corresponding to the fragment_id of the directory and jump to it.

May jump to the first section of a chapter based on catalog_id, etc. Thus, not only may jump to the first page of the chapter, but also may jump to a section within the chapter, that is, a page within the chapter.

In summary, the electronic text generation method of the embodiments of the present disclosure, the directory title is displayed at the multiple hierarchies, which improves the intuitiveness of the typesetting and displaying of the directory title and further enhances the reading experience.

To implement the above embodiments, the present disclosure also provides an electronic text generation apparatus.

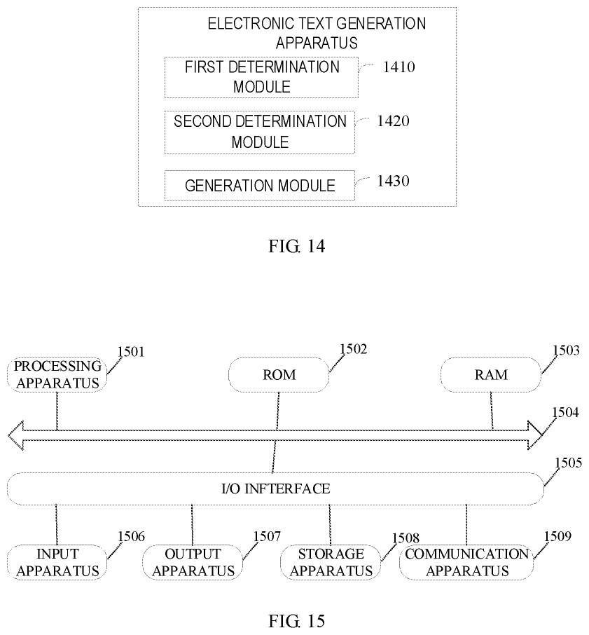

FIG. 14 is a structural schematic diagram of an electronic text generation device provided by the embodiments of the present disclosure, which may be implemented by software and/or hardware and may generally be integrated into an electronic device. As shown in FIG. 14, the apparatus includes: a first determination module 1410, a second determination module 1420, and a generation module 1430, wherein,
the first determination module 1410 configured to parse a plurality of document segment contents belonging to a preset document segment type of a published document, and determining display attribute information of each document segment content, wherein the preset document segment type comprises at least one of a body document segment type or a flyleaf document segment type;
the second determination module 1420 configured to determine a typesetting position of each document segment content based on preset typesetting attribute information of an electronic reader and the display attribute information;
the generation module 1430 configured to perform processing of typesetting and drawing for the plurality of document segment contents at the typesetting position based on the display attribute information to generate an electronic text corresponding to the published document.

The paging apparatus of the published document provided by the embodiments of the present disclosure may perform the electronic text generation method provided by any embodiments of the present disclosure, having the corresponding functional modules and beneficial effects of the execution method, which is similar to the implementation principle and is not repeated here.

To achieve the above embodiments, the present disclosure also provides a computer program product, comprising a computer program/instructions, when executed by a processor to implement the electronic text generation method provided by any of the embodiments of the present disclosure, having the execution method, which is similar to the implementation principle and is not repeated here.

FIG. 15 is a structural schematic diagram of an electronic device provided by the embodiments of the present disclosure.

Below with specific reference to FIG. 15, which shows a schematic structural diagram of an electronic device 1500 suitable for implementing the embodiments of the present disclosure. The terminal device in the embodiments of the present disclosure may include, without limitation to, a mobile terminal such as a mobile phone, a laptop computer, a digital broadcast receiver, a PDA (personal digital assistant), a PAD (tablet computer), a PMP (portable multimedia player), an on-board terminal (e.g., on-board navigation terminal) and the like, as well as a fixed terminal such as a digital TV, a desktop computer and the like. The electronic device shown in FIG. 15 is merely an example and should not be construed to impose any limitations on the functionality and use scope of the embodiments of the present disclosure.

As shown in FIG. 15, the electronic device may comprise processor (e.g., a central processor, a graphics processor) 1501 which is capable of performing various appropriate actions and processes in accordance with programs stored in a read only memory (ROM) 1502 or programs loaded from memory 1508 to a random access memory (RAM) 1503. In the RAM 1503, there are also stored various programs and data required by the electronic device 1500 when operating. The processor 1501, the ROM 1502 and the RAM 1503 are connected to one another via a bus 1504. An input/output (I/O) interface 1505 is also connected to the bus 1504.

Usually, the following means may be connected to the I/O interface 1505: input apparatus 1506 including a touch screen, a touch pad, a keyboard, a mouse, a camera, a microphone, an accelerometers, a gyroscope, or the like; output apparatus 1507, such as a liquid-crystal display (LCD), a loudspeaker, a vibrator, or the like; memory 1508, such as a magnetic tape, a hard disk or the like; and communication apparatus 1509. The communication apparatus 1509 allows the electronic device 1500 to perform wireless or wired communication with other device so as to exchange data with another device. While FIG. 15 shows the electronic device 1500 with various means, it should be understood that it is not required to implement or have all of the illustrated means. Alternatively, more or less means may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication apparatus 1509, or installed from the memory 15015, or installed from the ROM 1502. The computer program, when executed by the processor 1501, perform the above functions defined in the method of the embodiments of the present disclosure.

It should be noted that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium including or storing a program that may be used by or in conjunction with an instruction executing system, apparatus or device. In the present disclosure, the computer readable signal medium may include data signals propagated in the baseband or as part of the carrier waveform, in which computer readable program code is carried. Such propagated data signals may take a variety of forms, including without limitation to electromagnetic signals, optical signals, or any suitable combination of the foregoing. The computer readable signal medium may also be any computer readable medium other than a computer readable storage medium that may send, propagate, or transmit a program for use by, or in conjunction with, an instruction executing system, apparatus, or device. The program code contained on the computer readable medium may be transmitted by any suitable medium, including, but not limited to, a wire, a fiber optic cable, RF (radio frequency), etc., or any suitable combination thereof.

In some implementations, the client and server may communicate utilizing any currently known or future developed network protocol such as HTTP (HyperText Transfer Protocol) and may be interconnected with digital data communications (e.g., communication networks) of any form or medium. Examples of communication networks include local area networks (“LANs”), wide area networks (“WANs”), inter-networks (e.g., the Internet), and end-to-end networks (e.g., ad hoc end-to-end networks), as well as any currently known or future developed networks.

The above computer readable medium may be contained in the above electronic device; or it may exist separately and not be assembled into the electronic device.

The above computer readable medium carries one or more programs which, when executed by the electronic device, cause the electronic device to:
parsing a plurality of document segment contents belonging to a preset document segment type of a published document, and determining display attribute information of each document segment content, wherein the preset document segment type comprises at least one of a body document segment type or a flyleaf document segment type; then determining a typesetting position of each document segment content based on preset typesetting attribute information of an electronic reader and the display attribute information; and finally performing processing of typesetting and drawing for the plurality of document segment contents at the typesetting position based on the display attribute information to generate an electronic text corresponding to the published document. Thus, the electronic text is converted based on the original display attribute information of the published document, and various types of document segments of the published document are indiscriminately converted. This not only achieves the effect of mixed picture and text in the electronic text, but also retains the original display mode of the published document.

Computer program code for carrying out operations of the present disclosure may be written in one or more program designing languages or a combination thereof, which include without limitation to an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Units involved in the embodiments of the present disclosure as described may be implemented in software or hardware. The name of a unit does not form any limitation on the module itself.

The functionality described above may at least partly be performed, at least in part, by one or more hardware logic components. For example and in a non-limiting sense, exemplary types of hardware logic components that can be used include: field-programmable gate arrays (FPGA), application specific integrated circuits (ASICs), application specific standard products (ASSPs), systems on chips (SOCs), complex programmable logic devices (CPLDs), etc.

In the context of the present disclosure, the machine readable medium may be a tangible medium that can retain and store programs for use by or in conjunction with an instruction execution system, apparatus or device. The machine readable medium of the present disclosure can be a machine readable signal medium or a machine readable storage medium. The machine readable medium may include, but is not limited to, an electronic, magnetic, optical, electromagnetic, infrared or semiconductor system, apparatus or device, or any combination of the foregoing. More specific examples of the machine readable storage medium may include, without limitation to, the following: an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, an electronic text generation method provided by the present disclosure, comprising:
parsing a plurality of document segment contents belonging to a preset document segment type of a published document, and determining display attribute information of each document segment content, wherein the preset document segment type comprises at least one of a body document segment type or a flyleaf document segment type;
determining a typesetting position of each document segment content based on preset typesetting attribute information of an electronic reader and the display attribute information; and
performing processing of typesetting and drawing for the plurality of document segment contents at the typesetting position based on the display attribute information to generate an electronic text corresponding to the published document.

According to one or more embodiments of the present disclosure, the electronic text generation method provided by the present disclosure, wherein parsing the plurality of document segment contents belonging to the preset document segment type of the published document comprises:
determining a document segment start mark and a document segment end mark corresponding to the preset document segment type; and
parsing a document content between each document segment start mark and the adjacent document segment end mark to obtain the plurality of document segment contents.

According to one or more embodiments of the present disclosure, the electronic text generation method provided by the present disclosure, wherein determining the typesetting position of each document segment content based on preset typesetting attribute information of the electronic reader and the display attribute information comprises:
determining, based on the display attribute information, a first display size of each content unit in each document segment content;
determining, based on the typesetting attribute information, a second display size of each display unit in the electronic reader;
typesetting each content unit based on the second display size and the first display size to determine the typesetting position of each document segment content.

According to one or more embodiments of the present disclosure, the electronic text generation method provided by the present disclosure, wherein determining, based on the display attribute information, the first display size of each content unit in each document segment content, comprises:
if a content unit is text content, obtaining a size style and a font style of the text content;
determining a first display size of the text content based on the size style and font style;
if a content unit is picture content, obtaining a picture size of the picture content;
determining a first display size of the picture content based on the picture size.

According to one or more embodiments of the present disclosure, the electronic text generation method provided by the present disclosure, wherein if the preset document segment type is a type of flyleaf document segment, the method, after performing processing of typesetting and drawing for the plurality of document segment contents based on the display attribute information, further comprising:
obtaining a background picture of the flyleaf document segment;
rendering the background picture in a background area of a typesetting position corresponding to the flyleaf document segment.

According to one or more embodiments of the present disclosure, the electronic text generation method provided by the present disclosure, further comprising:
obtaining all directory titles of the published document;
obtaining a directory hierarchy identifier of each directory title based on a webpage code of the published document, and building a hierarchical order of all the directory titles based on the directory hierarchy identifier; performing processing of typesetting and drawing for all the directory titles in accordance with the hierarchical order based on the typesetting attribute information.

According to one or more embodiments of the present disclosure, the electronic text generation method provided by the present disclosure, wherein, determining all body document segment contents of the body document segment type of the published document;
obtaining, based on the webpage code of the published document, a belonged directory hierarchy identifier to which the body paragraph belongs;
determining, based on the belonged directory hierarchy identifier, target body paragraphs corresponding to the all directory titles in all the body document segment contents;
building, based on a typesetting position of the target body paragraphs, a correspondence between a typesetting beginning position of the target body paragraphs and the corresponding directory title for jumping to the corresponding typesetting beginning position based on the correspondence in response to a trigger operation of the directory title.

According to one or more embodiments of the present disclosure, the electronic text generation method provided by the present disclosure, further comprising:
obtaining display size information of a target display device;
paging the electronic text based on the display size information and the typesetting attribute information to generate a plurality of pagings corresponding to the electronic text.

According to one or more embodiments of the present disclosure, the electronic text generation method provided by the present disclosure, further comprising:
identifying whether the plurality of document segment contents contain at least one document segment content group meeting a preset association condition, wherein each document segment content group contains a plurality of document segment contents meeting the preset association condition;
if the at least one document segment content group is contained, determining whether the plurality of document segment contents in each document segment content group is on the same paging;
if not on the same paging, adjusting the plurality of document segment contents in the corresponding document segment content group to the same paging based on a preset adjustment policy.

According to one or more embodiments of the present disclosure, the electronic text generation method provided by the present disclosure, wherein adjusting the plurality of document segment contents in the corresponding document segment content group to the same paging based on the preset adjustment policy comprises:
adjusting a typesetting position of at least one document segment content in the corresponding document segment content group, so that a plurality of document segment contents in the corresponding document segment content group belong to the same paging; and/or,
adjusting a content display size of at least one document segment content in the corresponding document segment content group, so that a plurality of document segment contents in the corresponding document segment content group belong to the same paging.

According to one or more embodiments of the present disclosure, an electronic text generation apparatus provided by the present disclosure, comprising:
a first determination module configured to parse a plurality of document segment contents belonging to a preset document segment type of a published document, and determining display attribute information of each document segment content, wherein the preset document segment type comprises at least one of a body document segment type or a flyleaf document segment type;
a second determination module configured to determine a typesetting position of each document segment content based on preset typesetting attribute information of an electronic reader and the display attribute information;
a generation module configured to perform processing of typesetting and drawing for the plurality of document segment contents at the typesetting position based on the display attribute information to generate an electronic text corresponding to the published document.

According to one or more embodiments of the present disclosure, the electronic text generation apparatus provided by the present disclosure, the first determination module, specifically configured to:
determine a document segment start mark and a document segment end mark corresponding to the preset document segment type; and
parse a document content between each document segment start mark and the adjacent document segment end mark to obtain the plurality of document segment contents.

According to one or more embodiments of the present disclosure, the electronic text generation apparatus provided by the present disclosure, the second determination module, specifically configured to:
determine, based on the display attribute information, a first display size of each content unit in each document segment content;
determine, based on the typesetting attribute information, a second display size of each display unit in the electronic reader;
typeset each content unit based on the second display size and the first display size to determine the typesetting position of each document segment content.

According to one or more embodiments of the present disclosure, the electronic text generation apparatus provided by the present disclosure, the second determination module, specifically configured to:
if a content unit is text content, obtain a size style and a font style of the text content;
determine a first display size of the text content based on the size style and font style;
if a content unit is picture content, obtain a picture size of the picture content;
determine a first display size of the picture content based on the picture size.

According to one or more embodiments of the present disclosure, the electronic text generation apparatus provided by the present disclosure, if the preset document segment type is a type of flyleaf document segment, further comprising: a rendering module for:
obtaining a background picture of the flyleaf document segment;
rendering the background picture in a background area of a typesetting position corresponding to the flyleaf document segment.

According to one or more embodiments of the present disclosure, the electronic text generation apparatus provided by the present disclosure,

According to one or more embodiments of the present disclosure, the electronic text generation apparatus provided by the present disclosure, further comprising: a title building module for:
obtaining all directory titles of the published document;
obtaining a directory hierarchy identifier of each directory title based on a webpage code of the published document, and building a hierarchical order of all the directory titles based on the directory hierarchy identifier; performing processing of typesetting and drawing for all the directory titles in accordance with the hierarchical order based on the typesetting attribute information.

According to one or more embodiments of the present disclosure, the electronic text generation apparatus provided by the present disclosure, the title building module is further configured to:
determine all body document segment contents of the body document segment type of the published document;
obtain, based on the webpage code of the published document, a belonged directory hierarchy identifier to which the body paragraph belongs;
determine, based on the belonged directory hierarchy identifier, target body paragraphs corresponding to the all directory titles in all the body document segment contents;
building, based on a typesetting position of the target body paragraphs, a correspondence between a typesetting beginning position of the target body paragraphs and the corresponding directory title for jumping to the corresponding typesetting beginning position based on the correspondence in response to a trigger operation of the directory title.

According to one or more embodiments of the present disclosure, the electronic text generation apparatus provided by the present disclosure, further comprising: a paging module for:
obtaining display size information of a target display device;
paging the electronic text based on the display size information and the typesetting attribute information to generate a plurality of pagings corresponding to the electronic text.

According to one or more embodiments of the present disclosure, the electronic text generation apparatus provided by the present disclosure, the paging module is further configured to:
identify whether the plurality of document segment contents contain at least one document segment content group meeting a preset association condition, wherein each document segment content group contains a plurality of document segment contents meeting the preset association condition;
if the at least one document segment content group is contained, determine whether the plurality of document segment contents in each document segment content group is on the same paging;
if not on the same paging, adjust the plurality of document segment contents in the corresponding document segment content group to the same paging based on a preset adjustment policy.

According to one or more embodiments of the present disclosure, the electronic text generation apparatus provided by the present disclosure, the paging module is further configured to:
adjust a typesetting position of at least one document segment content in the corresponding document segment content group, so that a plurality of document segment contents in the corresponding document segment content group belong to the same paging; and/or,
adjust a content display size of at least one document segment content in the corresponding document segment content group, so that a plurality of document segment contents in the corresponding document segment content group belong to the same paging.

According to one or more embodiments of the present disclosure, an electronic device provided by the present disclosure, comprising:
a processor;
a memory for storing processor executable instructions;
the processor used to read the executable instructions from the memory and execute the instructions to implement any of the electronic text generation method provided by the present disclosure.

According to one or more embodiments of the present disclosure, a computer readable storage medium provided by the present disclosure, wherein the storage medium stores a computer program for performing any of the electronic text generation method provided by the present disclosure.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion includes several specific implementation details, they should not be construed as limiting the scope of the present disclosure. Some features described in the context of separate embodiments may also be realized in combination in a single embodiment. On the contrary, various features described in the context of a single embodiment may also be realized in multiple embodiments, either individually or in any suitable sub-combinations.

Although the subject matter has been described in language specific to structural features and/or methodological logical actions, it should be understood that the subject matter defined in the appended claims is not necessarily limited to the particular features or actions described above. On the contrary, the particular features and actions described above are merely exemplary forms of implementing the claims.

1. An electronic text generation method comprising:
parsing a plurality of document segment contents belonging to a preset document segment type of a published document, and determining display attribute information of each document segment content, wherein the preset document segment type comprises at least one of a body document segment type or a flyleaf document segment type;
determining a typesetting position of each document segment content based on preset typesetting attribute information of an electronic reader and the display attribute information; and
performing processing of typesetting and drawing for the plurality of document segment contents at the typesetting position based on the display attribute information to generate an electronic text corresponding to the published document.

2. The method of claim 1, wherein parsing the plurality of document segment contents belonging to the preset document segment type of the published document comprises:
determining a document segment start mark and a document segment end mark corresponding to the preset document segment type; and
parsing a document content between each document segment start mark and the adjacent document segment end mark to obtain the plurality of document segment contents.

3. The method of claim 1, wherein determining the typesetting position of each document segment content based on preset typesetting attribute information of the electronic reader and the display attribute information comprises:
determining, based on the display attribute information, a first display size of each content unit in each document segment content;
determining, based on the typesetting attribute information, a second display size of each display unit in the electronic reader;
typesetting each content unit based on the second display size and the first display size to determine the typesetting position of each document segment content.

4. The method of claim 3, wherein determining, based on the display attribute information, the first display size of each content unit in each document segment content, comprises:
if a content unit is text content, obtaining a size style and a font style of the text content;
determining a first display size of the text content based on the size style and font style;
if a content unit is picture content, obtaining a picture size of the picture content;
determining a first display size of the picture content based on the picture size.

5. The method of claim 1, wherein if the preset document segment type is a type of flyleaf document segment, the method, after performing processing of typesetting and drawing for the plurality of document segment contents based on the display attribute information, further comprising:
obtaining a background picture of the flyleaf document segment;
rendering the background picture in a background area of a typesetting position corresponding to the flyleaf document segment.

6. The method of claim 1, further comprising:
obtaining all directory titles of the published document;
obtaining a directory hierarchy identifier of each directory title based on a webpage code of the published document, and building a hierarchical order of all the directory titles based on the directory hierarchy identifier; performing processing of typesetting and drawing for all the directory titles in accordance with the hierarchical order based on the typesetting attribute information.

7. The method of claim 6, wherein,
determining all body document segment contents of the body document segment type of the published document;
obtaining, based on the webpage code of the published document, a belonged directory hierarchy identifier to which the body paragraph belongs;
determining, based on the belonged directory hierarchy identifier, target body paragraphs corresponding to the all directory titles in all the body document segment contents;
building, based on a typesetting position of the target body paragraphs, a correspondence between a typesetting beginning position of the target body paragraphs and the corresponding directory title for jumping to the corresponding typesetting beginning position based on the correspondence in response to a trigger operation of the directory title.

8. The method of claim 1, further comprising:
obtaining display size information of a target display device;
paging the electronic text based on the display size information and the typesetting attribute information to generate a plurality of pagings corresponding to the electronic text.

9. The method of claim 8, further comprising:
identifying whether the plurality of document segment contents contain at least one document segment content group meeting a preset association condition, wherein each document segment content group contains a plurality of document segment contents meeting the preset association condition;
if the at least one document segment content group is contained, determining whether the plurality of document segment contents in each document segment content group is on the same paging;
if not on the same paging, adjusting the plurality of document segment contents in the corresponding document segment content group to the same paging based on a preset adjustment policy.

10. The method of claim 9, wherein adjusting the plurality of document segment contents in the corresponding document segment content group to the same paging based on the preset adjustment policy comprises:
adjusting a typesetting position of at least one document segment content in the corresponding document segment content group, so that a plurality of document segment contents in the corresponding document segment content group belong to the same paging; and/or,
adjusting a content display size of at least one document segment content in the corresponding document segment content group, so that a plurality of document segment contents in the corresponding document segment content group belong to the same paging.

11-13. (canceled)

14. An electronic device, comprising:
a processor;
a memory for storing processor executable instructions;
the processor used to read the executable instructions from the memory and execute the instructions to implement an electronic text generation method, comprising:
parsing a plurality of document segment contents belonging to a preset document segment type of a published document, and determining display attribute information of each document segment content, wherein the preset document segment type comprises at least one of a body document segment type or a flyleaf document segment type;
determining a typesetting position of each document segment content based on preset typesetting attribute information of an electronic reader and the display attribute information; and
performing processing of typesetting and drawing for the plurality of document segment contents at the typesetting position based on the display attribute information to generate an electronic text corresponding to the published document.

15. The device of claim 14, wherein parsing the plurality of document segment contents belonging to the preset document segment type of the published document comprises:
determining a document segment start mark and a document segment end mark corresponding to the preset document segment type; and
parsing a document content between each document segment start mark and the adjacent document segment end mark to obtain the plurality of document segment contents.

16. The device of claim 14, wherein determining the typesetting position of each document segment content based on preset typesetting attribute information of the electronic reader and the display attribute information comprises:
determining, based on the display attribute information, a first display size of each content unit in each document segment content;
determining, based on the typesetting attribute information, a second display size of each display unit in the electronic reader;
typesetting each content unit based on the second display size and the first display size to determine the typesetting position of each document segment content.

17. The device of claim 16, wherein determining, based on the display attribute information, the first display size of each content unit in each document segment content, comprises:
if a content unit is text content, obtaining a size style and a font style of the text content;
determining a first display size of the text content based on the size style and font style;
if a content unit is picture content, obtaining a picture size of the picture content;
determining a first display size of the picture content based on the picture size.

18. The device of claim 14, wherein if the preset document segment type is a type of flyleaf document segment, the method, after performing processing of typesetting and drawing for the plurality of document segment contents based on the display attribute information, further comprising:
obtaining a background picture of the flyleaf document segment;
rendering the background picture in a background area of a typesetting position corresponding to the flyleaf document segment.

19. The device of claim 14, further comprising:
obtaining all directory titles of the published document;
obtaining a directory hierarchy identifier of each directory title based on a webpage code of the published document, and building a hierarchical order of all the directory titles based on the directory hierarchy identifier; performing processing of typesetting and drawing for all the directory titles in accordance with the hierarchical order based on the typesetting attribute information.

20. The device of claim 19, wherein,
determining all body document segment contents of the body document segment type of the published document;
obtaining, based on the webpage code of the published document, a belonged directory hierarchy identifier to which the body paragraph belongs;
determining, based on the belonged directory hierarchy identifier, target body paragraphs corresponding to the all directory titles in all the body document segment contents;
building, based on a typesetting position of the target body paragraphs, a correspondence between a typesetting beginning position of the target body paragraphs and the corresponding directory title for jumping to the corresponding typesetting beginning position based on the correspondence in response to a trigger operation of the directory title.

21. The device of claim 14, further comprising:
obtaining display size information of a target display device;
paging the electronic text based on the display size information and the typesetting attribute information to generate a plurality of pagings corresponding to the electronic text.

22. The device of claim 21, further comprising:
identifying whether the plurality of document segment contents contain at least one document segment content group meeting a preset association condition, wherein each document segment content group contains a plurality of document segment contents meeting the preset association condition;
if the at least one document segment content group is contained, determining whether the plurality of document segment contents in each document segment content group is on the same paging;
if not on the same paging, adjusting the plurality of document segment contents in the corresponding document segment content group to the same paging based on a preset adjustment policy.

23. A non-transitory computer readable storage medium, wherein the storage medium stores a computer program for performing an electronic text generation method, comprising:
parsing a plurality of document segment contents belonging to a preset document segment type of a published document, and determining display attribute information of each document segment content, wherein the preset document segment type comprises at least one of a body document segment type or a flyleaf document segment type;
determining a typesetting position of each document segment content based on preset typesetting attribute information of an electronic reader and the display attribute information; and
performing processing of typesetting and drawing for the plurality of document segment contents at the typesetting position based on the display attribute information to generate an electronic text corresponding to the published document.
